(19) United States
(12) Patent Application Publication
(10) Pub. No.: US 2022/0164796 A1
(43) Pub. Date: May 26, 2022

(54) SYSTEM, METHOD, AND COMPUTER PROGRAM PRODUCT FOR GENERATING ENHANCED N-GRAM MODELS

(71) Applicant: VISA INTERNATIONAL SERVICE ASSOCIATION, San Francisco, CA (US)

(72) Inventors: Tony Thomas Kollamparambil, Fremont, CA (US); Mohamed Nosseir, Castro Valley, CA (US)

(21) Appl. No.: 17/432,989

(22) PCT Filed: May 4, 2020
(86) PCT No.: PCT/US20/31319

§ 371 Date: Aug. 23, 2021

Related U.S. Application Data
(60) Provisional application No. 62/842,569, filed on May 3, 2019.

(51) Int. Cl. G06Q 20/40; G06N 7/00

(52) U.S. Cl. CPC G06Q 20/4016; G06N 7/005

(57) ABSTRACT

A method, system, and computer program product is provided for generating enhanced n-gram models for use with monitoring systems. The method includes determining that a leading pair of characters of a first data string does not match a leading pair of characters of a second data string and inserting a placeholder character at a first-index position in each data string. The method further includes inserting a placeholder character between each character pair of the first data string in which a first character matches a character of the second data string at a same index position and in which a second character matches a character of the second data string at an index position immediately following a same index position, and generating a similarity score based on the length of the data strings and triggering a remedial process in response to the similarity score exceeding a predetermined threshold.

### CROSS REFERENCE TO RELATED APPLICATIONS

This application is the United States national phase of International Application No. PCT/US2020/031319 filed May 4, 2020, and claims priority to U.S. Provisional Patent Application No. 62/842,569 filed on May 3, 2019, the disclosures of which are incorporated by reference herein in their entirety.

### BACKGROUND

### 1. Technical Field

This disclosure relates generally to data comparison modeling and, in non-limiting embodiments, systems, methods, and computer program products, for generating enhanced n-gram models for evaluation and triggering of remedial processes by monitoring systems.

### 2. Technical Considerations

Computerized string comparisons are a core function of various data processing systems, e.g., monitoring systems such as compliance and fraud detection systems. However, identifying two matching or related strings is more complicated than bit-by-bit equivalence. Two strings, which may represent the same object or entity, may have minor differences in data string sequence or arrangement, such that a strict equivalence comparison would reject the strings as non-matching. For example, a string of the name “Sara Lynn Smith” might refer to the same entity as a string of the name “Sarah Lynn Smith,” but a strict equivalence comparison would indicate the strings do not match. False negatives create technical complications for data processing systems, such as increased computation time to analyze rejected matches, manual review, loss of efficiency in communication caused by delays in detected matches, and/or the like.

Furthermore, while fuzzy matching techniques have been developed to relate non-equivalent strings, optimizing the identification of related data strings is crucial. False positives similarly create technical complications for data processing systems, such as increased computation time in acting on improperly matched strings, miscommunicated messages, false fraud detection and computer shutdowns, and/or the like. Moreover, prior methods may not properly account for comparing two sets of strings. For example, one set of strings may include a first name and last name, while a second set of strings may include a first name, middle name, and last name. Merely appending the strings in each set and comparing the strings directly would result in artificially low similarity scores.

There is a need in the art for an improved system and method to measure the similarity of two strings, so as to trigger action by monitoring systems based on detected matching strings. Furthermore, there is a need in the art for an improved system and method to evaluate the probability that two strings containing sequences of characters, or sets of strings, are related.

### SUMMARY

According to non-limiting embodiments or aspects, provided is a computer-implemented method. The method includes receiving, with at least one processor, a first data string in a first transaction request and a second data string in a second transaction request processed by a transaction processing server. The method also includes determining, with at least one processor, that a leading pair of characters of the first data string does not match a leading pair of characters of the second data string. The method further includes, in response to determining that the leading pair of characters of the first data string does not match the leading pair of characters of the second data string, inserting, with at least one processor, a placeholder character at a first-index position in the first data string and at a first-index position in the second data string. Placeholder characters are not present elsewhere in the first data string or the second data string. The method further includes determining, with at least one processor, at least one character pair of the first data string in which a first character of the at least one character pair matches a character of the second data string at a same index position as the first character and in which a second character of the at least one character pair matches a character of the second data string at an index position immediately following a same index position of the second character. The method further includes inserting, with at least one processor, a placeholder character between each character pair of the at least one character pair. The method further includes determining, with at least one processor, whether a length of the first data string or a length of the second data string is less than a predetermined n-gram length, and (i) in response to determining that the length of the first data string or the length of the second data string is less than the predetermined n-gram length, generating, with at least one processor, a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generating, with at least one processor, the similarity score based on an n-gram distance scoring model to compare the first data string and the second data string. The method further includes triggering, by a monitoring system in communication with the transaction processing server, a remedial process for the first transaction request and/or the second transaction request in response to the similarity score exceeding a predetermined threshold.

In some non-limiting embodiments or aspects, the monitoring system may be a compliance system. The remedial process executed by the compliance system may include modifying, with a compliance system server, the first transaction request and/or the second transaction request so that the first data string and the second data string are a same data string. The method may include updating, by the compliance system after executing the remedial process, a whitelist of users. The transaction processing server may be configured to authorize future transaction requests of users on the whitelist.

In some non-limiting embodiments or aspects, the monitoring system may be a fraud system. The remedial process executed by the fraud system may include identifying the first transaction request and/or the second transaction request as fraudulent and preventing authorization of the first transaction request and/or the second transaction request. The method may include updating, by the fraud system after executing the remedial process, a blacklist of users. The transaction processing server may be configured to deny authorization of future transaction requests of users on the blacklist.

In some non-limiting embodiments or aspects, the first data string may include a first set of character sequences and the second data string may include a second set of character sequences. The method may also include generating, with at least one processor, a combined similarity score of the first set of character sequences compared to the second set of character sequences. The combined similarity score may be based on a weighted probability score including a summed plurality of probability scores divided by a number of character sequences in the first set of character sequences. Each of the plurality of probability scores may represent a probability that a character sequence in the first set of character sequences exists in the second set of character sequences. The combined similarity score may also be based on a penalty value assessed for each character sequence in the second set of character sequences that does not exist in the first set of character sequences. Each probability score of the plurality of probability scores may be based on an n-gram distance model. The method may include triggering, by the monitoring system, the remedial process for the first transaction request and/or the second transaction request in response to the combined similarity score exceeding a predetermined threshold.

According to non-limiting embodiments or aspects, provided is a system including a transaction processing server including at least one processor and a monitoring system in communication with the transaction processing server. The transaction processing server is programmed and/or configured to receive a first data string in a first transaction request and a second data string in a second transaction request processed by a transaction processing server. The transaction processing server is programmed and/or configured to determine that a leading pair of characters of the first data string does not match a leading pair of characters of the second data string. The transaction processing server is programmed and/or configured to, in response to determining that the leading pair of characters of the first data string does not match the leading pair of characters of the second data string, insert a placeholder character at a first-index position in the first data string and at a first-index position in the second data string. Placeholder characters are not present elsewhere in the first data string or the second data string. The transaction processing server is programmed and/or configured to determine at least one character pair of the first data string in which a first character of the at least one character pair matches a character of the second data string at a same index position as the first character and in which a second character of the at least one character pair matches a character of the second data string at an index position immediately following a same index position of the second character. The transaction processing server is programmed and/or configured to insert a placeholder character between each character pair of the at least one character pair. The transaction processing server is programmed and/or configured to determine whether a length of the first data string or a length of the second data string is less than a predetermined n-gram length, and (i) in response to determining that the length of the first data string or the length of the second data string is less than the predetermined n-gram length, generate a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generate the similarity score based on an n-gram distance scoring model to compare the first data string and the second data string. The monitoring system is programmed and/or configured to trigger a remedial process for the first transaction request and/or the second transaction request in response to the similarity score exceeding a predetermined threshold.

In some non-limiting embodiments or aspects, the monitoring system may be a compliance system. The remedial process executed by the compliance system may include modifying, with a compliance system server, the first transaction request and/or the second transaction request so that the first data string and the second data string are a same data string. The compliance system may be programmed and/or configured to update, after executing the remedial process, a whitelist of users. The transaction processing server may be further programmed and/or configured to authorize future transaction requests of users on the whitelist.

In some non-limiting embodiments or aspects, the monitoring system may be a fraud system. The remedial process executed by the fraud system may include identifying the first transaction request and/or the second transaction request as fraudulent and preventing authorization of the first transaction request and/or the second transaction request. The fraud system may be programmed and/or configured to update, after executing the remedial process, a blacklist of users. The transaction processing server may be further programmed and/or configured to deny authorization of future transaction requests of users on the blacklist.

In some non-limiting embodiments or aspects, the first data string may include a first set of character sequences and the second data string may include a second set of character sequences. The transaction processing server may be programmed and/or configured to generate a combined similarity score of the first set of character sequences compared to the second set of character sequences. The combined similarity score may be based on a weighted probability score including a summed plurality of probability scores divided by a number of character sequences in the first set of character sequences. Each of the plurality of probability scores may represent a probability that a character sequence in the first set of character sequences exists in the second set of character sequences. The combined similarity score may also be based on a penalty value assessed for each character sequence in the second set of character sequences that does not exist in the first set of character sequences. Each probability score of the plurality of probability scores may be based on an n-gram distance model. The monitoring system may be further programmed and/or configured to trigger the remedial process for the first transaction request and/or the second transaction request in response to the combined similarity score exceeding a predetermined threshold.

According to non-limiting embodiments or aspects, provided is a computer program product including at least one non-transitory computer-readable medium including program instructions. The program instructions, when executed by at least one processor, cause the at least one processor to receive a first data string in a first transaction request and a second data string in a second transaction request processed by a transaction processing server. The program instructions cause the at least one processor to determine that a leading pair of characters of the first data string does not match a leading pair of characters of the second data string. The program instructions cause the at least one processor to, in response to determining that the leading pair of characters of the first data string does not match the leading pair of characters of the second data string, insert a placeholder character at a first-index position in the first data string and at a first-index position in the second data string. Placeholder characters are not present elsewhere in the first data string or the second data string. The program instructions cause the at least one processor to determine at least one character pair of the first data string in which a first character of the at least one character pair matches a character of the second data string at a same index position as the first character and in which a second character of the at least one character pair matches a character of the second data string at an index position immediately following a same index position of the second character. The program instructions cause the at least one processor to insert a placeholder character between each character pair of the at least one character pair. The program instructions cause the at least one processor to determine whether a length of the first data string or a length of the second data string is less than a predetermined n-gram length, and (i) in response to determining that the length of the first data string or the length of the second data string is less than the predetermined n-gram length, generate a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generate the similarity score based on an n-gram distance scoring model to compare the first data string and the second data string. The program instructions cause the at least one processor to trigger a remedial process of a monitoring system in communication with the transaction processing server for the first transaction request and/or the second transaction request in response to the similarity score exceeding a predetermined threshold.

In some non-limiting embodiments or aspects, the monitoring system may be a compliance system. The remedial process executed by the compliance system may include modifying, with a compliance system server, the first transaction request and/or the second transaction request so that the first data string and the second data string are a same data string. The program instructions may further cause the at least one processor to trigger the compliance system to update, after executing the remedial process, a whitelist of users. The transaction processing server may be configured to authorize future transaction requests of users on the whitelist.

In some non-limiting embodiments or aspects, the monitoring system may be a fraud system. The remedial process executed by the fraud system may include identifying the first transaction request and/or the second transaction request as fraudulent and preventing authorization of the first transaction request and/or the second transaction request. The program instructions may further cause the at least one processor to trigger the fraud system to update, after executing the remedial process, a blacklist of users. The transaction processing server may be configured to deny authorization of future transaction requests of users on the blacklist.

In some non-limiting embodiments or aspects, the first data string may include a first set of character sequences and the second data string may include a second set of character sequences. The program instructions may further cause the at least one processor to generate a combined similarity score of the first set of character sequences compared to the second set of character sequences. The combined similarity score may be based on a weighted probability score including a summed plurality of probability scores divided by a number of character sequences in the first set of character sequences, wherein each of the plurality of probability scores represents a probability that a character sequence in the first set of character sequences exists in the second set of character sequences. The combined similarity score may also be based on a penalty value assessed for each character sequence in the second set of character sequences that does not exist in the first set of character sequences. The program instructions may further cause the at least one processor to trigger the monitoring system to execute the remedial process for the first transaction request and/or the second transaction request in response to the combined similarity score exceeding a predetermined threshold. Each probability score of the plurality of probability scores may be based on an n-gram distance model.

According to non-limiting embodiments or aspects, provided is a computer-implemented method. The method includes receiving, with at least one processor, a first set of strings and a second set of strings. The method also includes generating, with at least one processor, a similarity score of the first set of strings compared to the second set of strings. The similarity score is based on a weighted probability score, including a summed plurality of probability scores divided by a number of strings in the first set of strings, wherein each of the plurality of probability scores represents a probability that a string in the first set of strings exists in the second set of strings. The similarity score is also based on a penalty value assessed for each string in the second set of strings that does not exist in the first set of strings. Each probability score of the plurality of probability scores is based on an n-gram distance model.

Other non-limiting embodiments or aspects will be set forth in the following numbered clauses:

Clause 1: A computer-implemented method comprising: receiving, with at least one processor, a first data string in a first transaction request and a second data string in a second transaction request processed by a transaction processing server; determining, with at least one processor, that a leading pair of characters of the first data string does not match a leading pair of characters of the second data string; in response to determining that the leading pair of characters of the first data string does not match the leading pair of characters of the second data string, inserting, with at least one processor, a placeholder character at a first-index position in the first data string and at a first-index position in the second data string, wherein placeholder characters are not present elsewhere in the first data string or the second data string; determining, with at least one processor, at least one character pair of the first data string in which a first character of the at least one character pair matches a character of the second data string at a same index position as the first character and in which a second character of the at least one character pair matches a character of the second data string at an index position immediately following a same index position of the second character; inserting, with at least one processor, a placeholder character between each character pair of the at least one character pair; determining, with at least one processor, whether a length of the first data string or a length of the second data string is less than a predetermined n-gram length, and (i) in response to determining that the length of the first data string or the length of the second data string is less than the predetermined n-gram length, generating, with at least one processor, a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generating, with at least one processor, the similarity score based on an n-gram distance scoring model to compare the first data string and the second data string; and triggering, by a monitoring system in communication with the transaction processing server, a remedial process for the first transaction request and/or the second transaction request in response to the similarity score exceeding a predetermined threshold.

Clause 2: The computer-implemented method of clause 1, wherein the monitoring system is a compliance system, and wherein the remedial process executed by the compliance system comprises modifying, with a compliance system server, the first transaction request and/or the second transaction request so that the first data string and the second data string are a same data string.

Clause 3: The computer-implemented method of clause 1 or 2, further comprising updating, by the compliance system after executing the remedial process, a whitelist of users, wherein the transaction processing server is configured to authorize future transaction requests of users on the whitelist.

Clause 4: The computer-implemented method of any of clauses 1-3, wherein the monitoring system is a fraud system, and wherein the remedial process executed by the fraud system comprises identifying the first transaction request and/or the second transaction request as fraudulent and preventing authorization of the first transaction request and/or the second transaction request.

Clause 5: The computer-implemented method of any of clauses 1-4, further comprising updating, by the fraud system after executing the remedial process, a blacklist of users, wherein the transaction processing server is configured to deny authorization of future transaction requests of users on the blacklist.

Clause 6: The computer-implemented method of any of clauses 1-5, wherein the first data string comprises a first set of character sequences and the second data string comprises a second set of character sequences, the method further comprising: generating, with at least one processor, a combined similarity score of the first set of character sequences compared to the second set of character sequences, the combined similarity score based on: a weighted probability score comprising a summed plurality of probability scores divided by a number of character sequences in the first set of character sequences, wherein each of the plurality of probability scores represents a probability that a character sequence in the first set of character sequences exists in the second set of character sequences; and a penalty value assessed for each character sequence in the second set of character sequences that does not exist in the first set of character sequences; wherein each probability score of the plurality of probability scores is based on an n-gram distance model.

Clause 7: The computer-implemented method of any of clauses 1-6, further comprising triggering, by the monitoring system, the remedial process for the first transaction request and/or the second transaction request in response to the combined similarity score exceeding a predetermined threshold.

Clause 8: A system comprising a transaction processing server including at least one processor and a monitoring system in communication with the transaction processing server, wherein the transaction processing server is programmed and/or configured to: receive a first data string in a first transaction request and a second data string in a second transaction request processed by a transaction processing server; determine that a leading pair of characters of the first data string does not match a leading pair of characters of the second data string; in response to determining that the leading pair of characters of the first data string does not match the leading pair of characters of the second data string, insert a placeholder character at a first-index position in the first data string and at a first-index position in the second data string, wherein placeholder characters are not present elsewhere in the first data string or the second data string; determine at least one character pair of the first data string in which a first character of the at least one character pair matches a character of the second data string at a same index position as the first character and in which a second character of the at least one character pair matches a character of the second data string at an index position immediately following a same index position of the second character; insert a placeholder character between each character pair of the at least one character pair; determine whether a length of the first data string or a length of the second data string is less than a predetermined n-gram length, and (i) in response to determining that the length of the first data string or the length of the second data string is less than the predetermined n-gram length, generate a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generate the similarity score based on an n-gram distance scoring model to compare the first data string and the second data string; and wherein the monitoring system is programmed and/or configured to trigger a remedial process for the first transaction request and/or the second transaction request in response to the similarity score exceeding a predetermined threshold.

Clause 9: The system of clause 8, wherein the monitoring system is a compliance system, and wherein the remedial process executed by the compliance system comprises modifying, with a compliance system server, the first transaction request and/or the second transaction request so that the first data string and the second data string are a same data string.

Clause 10: The system of clause 8 or 9, wherein the compliance system is programmed and/or configured to update, after executing the remedial process, a whitelist of users, and wherein the transaction processing server is further programmed and/or configured to authorize future transaction requests of users on the whitelist.

Clause 11: The system of any of clauses 8-10, wherein the monitoring system is a fraud system, and wherein the remedial process executed by the fraud system comprises identifying the first transaction request and/or the second transaction request as fraudulent and preventing authorization of the first transaction request and/or the second transaction request.

Clause 12: The system of any of clauses 8-11, wherein the fraud system is programmed and/or configured to update, after executing the remedial process, a blacklist of users, and wherein the transaction processing server is further programmed and/or configured to deny authorization of future transaction requests of users on the blacklist.

Clause 13: The system of any of clauses 8-12, wherein the first data string comprises a first set of character sequences and the second data string comprises a second set of character sequences, and wherein the transaction processing server is further programmed and/or configured to: generate a combined similarity score of the first set of character sequences compared to the second set of character sequences, the combined similarity score based on: a weighted probability score comprising a summed plurality of probability scores divided by a number of character sequences in the first set of character sequences, wherein each of the plurality of probability scores represents a probability that a character sequence in the first set of character sequences exists in the second set of character sequences; and a penalty value assessed for each character sequence in the second set of character sequences that does not exist in the first set of character sequences; wherein each probability score of the plurality of probability scores is based on an n-gram distance model.

Clause 14: The system of any of clauses 8-13, wherein the monitoring system is further programmed and/or configured to trigger the remedial process for the first transaction request and/or the second transaction request in response to the combined similarity score exceeding a predetermined threshold.

Clause 15: A computer program product comprising at least one non-transitory computer-readable medium including program instructions that, when executed by at least one processor, cause the at least one processor to: receive a first data string in a first transaction request and a second data string in a second transaction request processed by a transaction processing server; determine that a leading pair of characters of the first data string does not match a leading pair of characters of the second data string; in response to determining that the leading pair of characters of the first data string does not match the leading pair of characters of the second data string, insert a placeholder character at a first-index position in the first data string and at a first-index position in the second data string, wherein placeholder characters are not present elsewhere in the first data string or the second data string; determine at least one character pair of the first data string in which a first character of the at least one character pair matches a character of the second data string at a same index position as the first character and in which a second character of the at least one character pair matches a character of the second data string at an index position immediately following a same index position of the second character; insert a placeholder character between each character pair of the at least one character pair; determine whether a length of the first data string or a length of the second data string is less than a predetermined n-gram length, and (i) in response to determining that the length of the first data string or the length of the second data string is less than the predetermined n-gram length, generate a similarity score based on a number of matching character pairs at same indexes in the first data string and the second data string in relation to the total number of character pairs, or (ii) in response to determining that the length of the first data string and the length of the second data string are greater than or equal to the predetermined n-gram length, generate the similarity score based on an n-gram distance scoring model to compare the first data string and the second data string; and trigger a remedial process of a monitoring system in communication with the transaction processing server for the first transaction request and/or the second transaction request in response to the similarity score exceeding a predetermined threshold.

Clause 16: The computer program product of clause 15, wherein the monitoring system is a compliance system, and wherein the remedial process executed by the compliance system comprises modifying, with a compliance system server, the first transaction request and/or the second transaction request so that the first data string and the second data string are a same data string.

Clause 17: The computer program product of clause 15 or 16, wherein the program instructions further cause the at least one processor to trigger the compliance system to update, after executing the remedial process, a whitelist of users, wherein the transaction processing server is configured to authorize future transaction requests of users on the whitelist.

Clause 18: The computer program product of any of clauses 15-17, wherein the monitoring system is a fraud system, and wherein the remedial process executed by the fraud system comprises identifying the first transaction request and/or the second transaction request as fraudulent and preventing authorization of the first transaction request and/or the second transaction request.

Clause 19: The computer program product of any of clauses 15-18, wherein the program instructions further cause the at least one processor to trigger the fraud system to update, after executing the remedial process, a blacklist of users, wherein the transaction processing server is configured to deny authorization of future transaction requests of users on the blacklist.

Clause 20: The computer program product of any of clauses 15-19, wherein the first data string comprises a first set of character sequences and the second data string comprises a second set of character sequences, and wherein the program instructions further cause the at least one processor to: generate a combined similarity score of the first set of character sequences compared to the second set of character sequences, the combined similarity score based on: a weighted probability score comprising a summed plurality of probability scores divided by a number of character sequences in the first set of character sequences, wherein each of the plurality of probability scores represents a probability that a character sequence in the first set of character sequences exists in the second set of character sequences; and a penalty value assessed for each character sequence in the second set of character sequences that does not exist in the first set of character sequences; and trigger the monitoring system to execute the remedial process for the first transaction request and/or the second transaction request in response to the combined similarity score exceeding a predetermined threshold, wherein each probability score of the plurality of probability scores is based on an n-gram distance model.

Clause 21: A computer-implemented method comprising: receiving, with at least one processor, a first set of strings and a second set of strings; generating, with at least one processor, a similarity score of the first set of strings compared to the second set of strings, wherein the similarity score is based on a weighted probability score comprising a summed plurality of probability scores divided by a number of strings in the first set of strings, wherein each of the plurality of probability scores represents a probability that a string in the first set of strings exists in the second set of strings, wherein the similarity score is based on a penalty value assessed for each string in the second set of strings that does not exist in the first set of strings, and wherein each probability score of the plurality of probability scores is based on an n-gram distance model.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for generating and using enhanced n-gram models according to some non-limiting embodiments or aspects;

FIG. 2 is a schematic diagram of a system for generating and using enhanced n-gram models according to some non-limiting embodiments or aspects;

FIG. 3 is a flow diagram of a method for generating and using enhanced n-gram models according to some non-limiting embodiments or aspects;

FIG. 4 is a flow diagram of a method for generating and using enhanced n-gram models according to some non-limiting embodiments or aspects;

FIG. 5 is a flow diagram of a method for generating and using enhanced n-gram models according to some non-limiting embodiments or aspects; and

FIG. 6 illustrates example components of a device used in connection with non-limiting embodiments.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “string” may refer to any sequence or set of data that may include a set of characters, numbers, spaces, nulls, and/or the like. A string may be empty, and the items of the set within a string may be referenced by index position (e.g., wherein “0” or “1” represents the first item in the set, and subsequent items are countably higher).

### Foundation for Embodiments

Unigram and Edit Distance lacks contextual sensitivity and performance varies based on the variations of the algorithm. The concept of n-gram similarity and distance generalizes the standard unigram string similarity and distance. Described systems and methods provide variations of n-gram similarity and distance, which show that the edit distance the length of the longest common subsequence (“LCS”) are special cases of n-gram distance and similarity, respectively. Described are formal definitions of n-gram similarity and distance, together with efficient algorithms for computing them in a context sensitive dataset. Described systems and methods formulate a family of word similarity measures based on n-grams that outperform their unigram and pure n-gram equivalents. Described are new, enhanced versions of n-gram measurement for computing the distance of two strings that are context sensitive, including a formula for computing the final distance score of phrases, sentence, names, and the like, where phrases, sentences, and names are composed of one or more strings. The described final score captures the probability that each string in the shorter full phrases, sentences, names, and the like exist in the longer phrases, sentences, names, and the like.

### Unigram Similarity

Unigram similarity describes the length of the LCS and may be used as a measure of string similarity. The standard formulation of the LCS problem is as follows. Given a sequence X=x₁ . . . xₖ, another sequence Z=z₁ . . . zₘ is a subsequence of X if there exists a strictly increasing sequence i₁, . . . , iₘ of indices of X such that for all j=1, . . . , m, there is equivalence xᵢ_{ⱼ}=zⱼ.

For example, “table” is a subsequence of “patentable.” Given two sequences X and Y, there may exist a common subsequence Z if Z exists as a subsequence for both X and Y. In the LCS problem, two sequences may serve as an input from which to identify a maximum-length common subsequence. For example, the LCS of “content” and “patentable” is “tent.” The LCS problem can be solved efficiently used dynamic programming. For the purposes of the below description, the length of the LCS is the focus rather than the data of the LCS itself. The length of the LCS may be described as a function of two strings.

Consider the following formal, recursive definition of the function s(X,Y), which represents the length of the LCS given input sequences X and Y. Let X=x1 . . . x/xk and Y=y1 . . . yl be strings of length k and l, respectively. For the purpose of the below description, consider X and Y to be composed of symbols of a finite alphabet. The following notational shorthand may be used to represent a pair of prefixes of X and Y:

Γi,j=(x₁ . . . xᵢ, yᵢ . . . yⱼ) Formula 1:

The following notational shorthand may be used to represent a pair of suffixes of X and Y:

Γ*=(xᵢ₊₁ . . . xₖ, yⱼ₊₁ . . . yᵢ) Formula 2:

For strings of length one or less, the following direct definitions may be used:

$$s ( x , ϵ ) = 0 , \\ s ( ϵ , y ) = 0 , \\ s ( x , y ) = \{ \begin{matrix}1 if x = y \\ 0 otherwise\end{matrix} \qquad Formula 3$$

where ε denotes an empty string, and x and y denote single symbols.

For longer strings, s may be defined recursively:

$$s ( X , Y ) = s ( {Γ}_{k , l} ) = {max}_{i , j} ( s ( {Γ}_{i , j} ) + s ( {Γ}_{i , j}^{*} ) ) \qquad Formula 4$$

The values of l and j in the above formula are constrained by the requirement that both Γi,j and Γ* are non-empty. In particular, the admissible values of i and j may be represented by the following set of pairs:

D(k, l)={0, . . . , k}×{0, . . . , l}−{(0,0), (k,l)} Formula 5:

By way of example, D(2,1)={(0,1), (1,0), (1,1), (2,0)}. Therefore, it can be inductively shown that s(X,Y) is always equal to the length of the LCS of strings X and Y.

The recursive definition makes use of the semi-compositionality of the LCS. It should be recognized that the LCS of concatenated strings is not necessarily equal to the sum of the respective LCSs. For example, ∥LCS(ab, a)∥=1 and ∥LCS(c, bc)∥=1, but ∥LCS(abc,abc)∥=3. However, the LCS of concatenated strings is always at least as long as the concatenation of their respective LCS:

s(X₁, Y₁)+s(X₂, Y₂)≤s(X₁+X₂, Y₁+Y₁+Y₂) Formula 6:

In view of the foregoing, s(X,Y) may be considered super additive, rather than compositional. The LCS of two strings may be composed by concatenating the LCS of their substrings, provided that the decomposition of the strings into substrings preserves all identity matches in the original LCS.

### N-Gram Similarity

A purpose of n-gram similarity is to generalize the concept of the longest common subsequence to encompass n-grams, rather than just unigrams. N-gram similarity may be formulated as a function Sn, where n is a fixed parameter. Si may be considered equivalent to a unigram similarity function.

To provide a concise recursive definition of n-gram similarity, the convention regarding Γ may be modified. When assessing n-grams for n>1, Γ_{i,j} and Γ*_{i,j} may be required to contain at least one complete n-gram, which is consistent for the previous convention for n=1. If both strings are shorter than n, sₙ is undefined.

In the simplest case, when there is only one complete n-gram in either of the strings, n-gram similarity is defined to be zero:

sₙ(Γk,l)=0 if (k=n∧l<n)∨(k<n∧l=n) Formula 7:

Let Γⁿ=(xᵢ₊₁ . . . xᵢ₊ₙ, yⱼ₊₁ . . . yⱼ₊ₙ) be a pair of n-grams in X and Y. If both strings contain exactly one n-gram, the initial definition is strictly binary: a value of 1 if the n-grams are identical, and a value of 0 otherwise. For longer strings, n-gram similarity may be defined recursively:

$$s ( X , Y ) = s ( {Γ}_{k , l} ) = {max}_{i , j} ( {s}_{n} ( {Γ}_{i + n - 1 , j + n - 1} ) + {s}_{n} ( {Γ}_{i , j}^{*} ) ) \qquad Formula 8$$

The values of i and j in the preceding formula are constrained by the requirement that both Γ_{i,j} and Γ* contain at least one n-gram. In particular, the admissible values of i and j may be given by the expression D(k−n+1, l−n+1), where D is the set of pairs defined above.

As in the case of s, a set of three decompositions is sufficient for computing sₙ:

sₙ(Γ_{k,l})=max(sₙ(Γ_{k-1,l}), sₙ(Γ_{k,l-1}), sₙ(Γ_{k-1,l-1})+sₙ(Γ_{k-n,l-n}ⁿ)) Formula 9:

The above binary n-gram similarity formula may be refined to produce a comprehensive n-gram similarity formula (to compute the standard unigram similarity between n-grams) and a positional n-gram similarity formula (to count identical unigrams in corresponding positions within n-grams), shown below, respectively:

$$\begin{matrix}{s}_{n} ( {Γ}_{i , j}^{n} ) = \frac{1}{n} {s}_{1} ( {Γ}_{i , j}^{n} ) & Formula 10 \\ {s}_{n} ( {Γ}_{i , j}^{n} ) = \frac{1}{n} {\sum }_{u = 1}^{n} {s}_{1} ( {x}_{i + u} , {y}_{j + u} ) & Formula 11\end{matrix}$$

An advantage of positional n-gram similarity is that it can be computed comparatively faster than the comprehensive n-gram similarity.

### N-Gram Distance

Since the standard edit distance is almost a dual notion to the length of the LCS, the definition of n-gram distance only slightly differs from the definition of n-gram similarity. The recursive definitions of edit distance are as follows:

$$\begin{matrix}d ( x , ϵ ) = 0 , \\ d ( ϵ , y ) = 0 , \\ d ( x , y ) = \{ \begin{matrix}1 if x = y \\ 0 otherwise\end{matrix} & Formula 12 \\ d ( X , Y ) = d ( {Γ}_{k , l} ) = {min}_{i , j} ( d ( {Γ}_{i , j} ) + d ( {Γ}_{i , j}^{*} ) ) & Formula 13\end{matrix}$$

An alternative formulation of edit distance with a reduced set of decompositions is as follows:

$$d ( X , Y ) = d ( {Γ}_{k , l} ) = min ( d ( {Γ}_{k - 1 , l} ) + 1 , \\ d ( {Γ}_{k , l - 1} ) + 1 , \\ d ( {Γ}_{k - 1 , l - 1} ) + d ( {x}_{k} , {y}_{l} ) ) \qquad Formula 14$$

The definition of n-gram edit distance is as follows:

$$\begin{matrix}{d}_{n} ( {Γ}_{k , l} ) = 1 if ( k = n ⩓ l < n ) ⩔ ( k < n ⩓ l = n ) & Formula 15 \\ {d}_{n} ( {Γ}_{n , n} ) = {d}_{n} ( {Γ}_{0 , 0}^{n} ) = \{ \begin{matrix}0 if {∀}_{1 \leq u \leq n} {x}_{u} = {y}_{u} \\ 1 otherwise\end{matrix} & Formula 16 \\ {d}_{n} ( {Γ}_{k , l} ) = {min}_{i , j} ( {d}_{n} ( {Γ}_{i + n - 1 , j + n - 1} ) + {d}_{n} ( {Γ}_{i , j}^{*} ) ) & Formula 17\end{matrix}$$

An alternative formulation of n-gram distance is as follows:

d(Γ_{k,l})=min(d(Γ_{k-1,l})+1, d(Γ_{k,l-1})+1, d(Γ_{k-1,l-1})+d(Γ_{k-n,l-n}ⁿ)) Formula 18:

The variations of algorithms that were evaluated and tested include:
i. Jaro-Winkler and variations of Jaro and Winkler algorithms
ii. Levenshtein Distance, and Damerau-Levenshtein distance algorithms
iii. NYSIIS
iv. Soundex and Refined Soundex
v. N-Gram
vi. Longest common subsequence
vii. Hamming Distance

Provided is an n-gram distance algorithm for computing the n-gram distance of strings X and Y:

```
N-Gram Distance (X,Y)  //Input strings are X and Y. And N is
the size of gram/substring
  K ← length(X)  //K is the length of Input #1 X
  L ← length(Y )  //L is the length of Input #2 Y
  for u←1 to N−1 do
    X ← x′₁ + X  //Augment X with Prefix x′
    Y ← y′₁ + Y  //Augment X with Prefix y′
  for i←0 to K do  //K is the length of Input #1 X
    D[i, 0] ← i  //Initialize a two dimensional array
double [K,L] with positional value
    /* Example:
      [0.0 0.0 0.0 0.0]
      [1.0 0.0 0.0 0.0]
      [2.0 0.0 0.0 0.0]
      */
  for j←1 to L do  //L is the length of Input #2 Y
    D[0, j] ← j  //Set Value double [0.0, 1.0, 2.0, etc.]
        /* Example:
      [0.0 1.0 2.0 3.0]
      [1.0 0.0 0.0 0.0]
      [2.0 0.0 0.0 0.0]
      */
  for i←1 to K do  //K is the length of Input #1 X
    for j ← 1 to L do  //L is the length of Input #2 Y
      D[i, j] ← min (D[i−1, j] + 1, [i, j−1] + 1,
D[i−1, j−1] + d_{N}(Γ^{N}_{i-1,} ⱼ₋₁))
      //D[1,1] = min(2.0, 2.0, 0 + distance
return D[K, L] / max(K, L)
```

### Enhanced N-Gram Distance

The n-gram measures were evaluated on various word-comparison tasks with the values n=2 and n=3, which provides relative computational speed and high overall accuracy. We have analyzed the results of n-gram distance over 75k words, strings from various online dictionaries, identified the patterns, and enhanced the algorithm until a sufficient accuracy was reached. During this process, critical weaknesses of n-gram were identified. According to non-limiting embodiments, the n-gram algorithm is enhanced with position-based optimizations and length normalizations to reduce the impact of weakness, thereby improving overall accuracy.

In non-limiting embodiments, the enhanced N-Gram Distance Algorithm with position-based optimizations and length normalizations is as follows:

```
Enhanced-N-Gram-Distance (X,Y) //Input strings are X and Y.
And N is the size of gram/substring
  K ← LENGTH(X) //K is the length of Input #1 X
  L ← LENGTH(Y)  //L is the length of Input #2 Y
  if K = 0 AND L = 0
    RETURN 1  //Return 1/match when both strings are
empty
if K = 0 OR L = 0
    RETURN 0  //Return 0/no match when one side is
empty
  LD = ABS(K − L)  //LD is a an absolute value of length
difference between length of X & Y
  J = 0
  EDITS = 0
  PREFIX = ‘*’  //it could be any character which is not
present in the X or Y
  if K != L AND LD < N  //Normalize inputs when the
length(X) − Length(Y) < N
    if K > L  //Swap Inputs when length(X) is greater
than length(Y)
      SWAP (X, Y)
    for I ← 0 TO K DO
      IF I = 0 AND X[I] != Y[J] AND X[I+1] != Y[J+1]
        // Add a prefix when only first char of
inputs are different from one another
        X = PREFIX + X
        Y = PREFIX + Y
        EDITS ++
        J ++:
      ELSE IF I > 0 AND X[I] != Y[J] AND X[I−1] ==
Y[J−1] AND X[I] == Y[J+1]  //substitute/add prefix when one
side lacks a letter between matching substrings
        X = X[0 − (J + EDITS −1)] + PREFIX + X[I
+ EDITS, K + EDITS
        J = J+2
      ELSE
        J++
  K ← LENGTH(_X)
  L ← LENGTH(_Y)
  IF K < N OR L < N  //Compute score without N-gram when
one length of any one input is < N
    COST = 0
    FOR I ← 0 TO MIN (K,L) DO
      IF X[I] = Y[I]
        COST ++
    RETURN COST/MAX((X, Y)  //Compute distance
  else
    return N-Gram-Distance(X, Y);  //Refer to N-Gram
Distance Algorithm
```

The input X and Y go through various other normalizations. For example, the inputs may be normalized by phonetic, gender, proximity, and/or the like.

The above enhanced n-gram algorithm was tested in a software application that compares human and business partners name against a widely accredited, public dataset. Approximately 8 million obfuscate human names were evaluated that contain 2 or more sub-names (e.g., first, middle, and surnames) against 4 million publically available datasets. The scores and results were more accurate in comparison with an unmodified n-gram-distance algorithm. A new measure/model is provided for computing a distance score of two full names that contain one or more sub-names. Enhanced-N-Gram-Distance Scoring Model for Computing Final Distance Score of Sentences or Names Composed of one or more Words/Sub-Names.

Problems arise when matching two full names: Na, which is composed of n sub-names and name Nb, which is composed of m sub-names. Assume n<=m.

Given the assumption n<=m, the problem is to produce a score S that measures the probability that Na and Nb are the same. In other words, S indicates the probability that all of the sub-names in Na exist in Nb. This translates to:

$$S = - ( m - n ) * K + \frac{1}{n} {\sum }_{i = 1}^{n} S ( i ) \qquad Formula 19$$

In the above equation, S(i) is the probability score that the i^{th} sub-name in Na exists in Nb regardless of the order. S(i) must be above the acceptance threshold T to be included. If a sub-name i has S(i) less than the threshold T, S(i) is set to 0. K is a constant that denotes a score penalty assessed for each name that exists in Nb but not in Na. The final score captures the probability that each sub-name in the shorter full name exists in the longer full name.

### Further Description

Non-limiting embodiments or aspects of the present disclosure improve over existing systems by improving the efficiency of string-based comparisons. False negatives are reduced, which reduces subsequent processing time and memory required to rectify initially mismatched data strings. False positives are also reduced, which reduces blocked or canceled processing activity due to misidentified matches in a dependent data processing server. The present disclosure also reduces the requirement to run multiple text comparison models by improving initial comparison accuracy, which reduces the overall computer processing demand on the system.

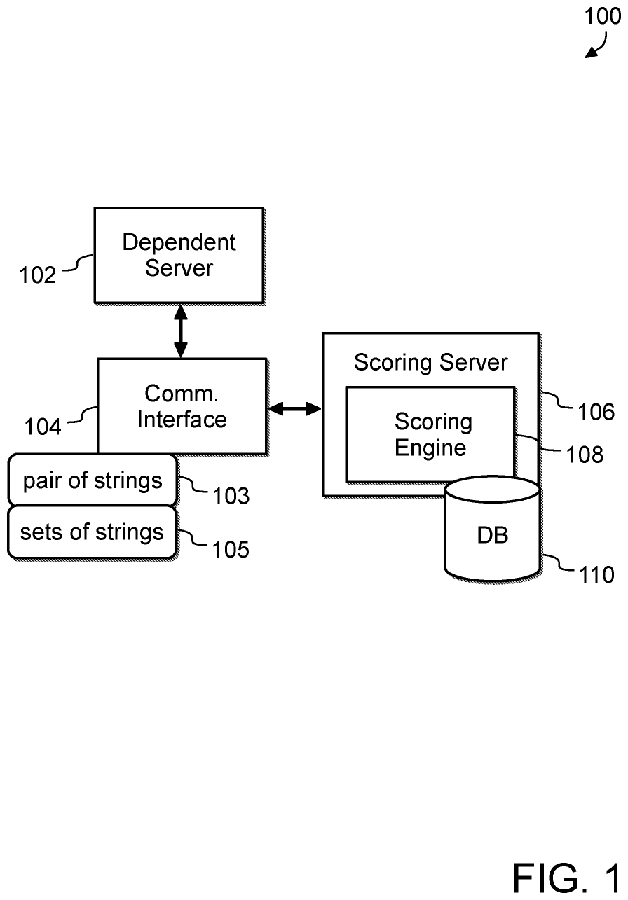

Referring to FIG. 1, provided is a system 100 according to non-limiting embodiments or aspects. The system 100 may include a dependent server 102, such as a transaction processing server or a server of a monitoring system, that requires a comparison of two or more data strings. A dependent server 102 may be a compliance system server, fraud detection server, transaction processing server, and/or the like, configured to compare a list of input strings (e.g., names) to a reference list of strings (e.g., names), such as to determine matches which may constitute a whitelist or blacklist of users, transactions, server activity, and/or the like. The system 100 may include more than one dependent server 102. The dependent server 102 (e.g., transaction processing server) may communicate a pair of strings 103 or sets of strings 105 to a scoring server 106 via a communication interface 104 (e.g., an application programming interface, a message broker, and/or the like) for comparison of the pair of strings 103 or sets of strings 105. The communication interface 104 may be integral to the dependent server 102 and/or the scoring server 106. The dependent server 102 may also be the same server as the scoring server 106 (e.g., a transaction processing server). The scoring server 106 may include a scoring engine 108 programmed and/or configured to compare two or more strings or two or more sets of strings and generate a similarity score. A similarity score may be numerical, categorical, ordinal, and/or the like. Strings received by the scoring server 106 for comparison may be stored in a database 110 that is in communication with the scoring server 106. It will be appreciated that the dependent server 102 may communicate any two or more strings to the scoring server 106 for comparison in any combination of comparisons thereof, wherein each base comparison constitutes a comparison of a pair of strings 103. The scoring server 106 may carry out one or more of the enhanced n-gram model comparisons described above to generate similarity scores for a pair of strings 103 or sets of strings 105.

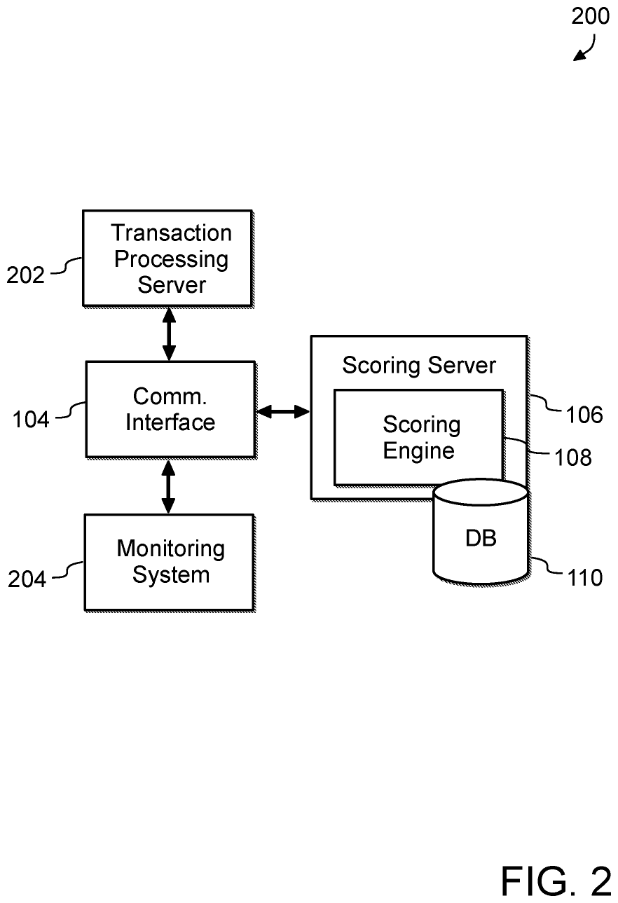

Referring to FIG. 2, provided is a system 200 according to non-limiting embodiments. The system 200 may include a transaction processing server 202 that requires a comparison of two or more data strings. The transaction processing server 202 may receive one or more data strings in one or more transaction requests for comparison, such as during processing of the transaction requests. The system 200 also includes a monitoring system 204 (e.g., a compliance system, a fraud system, etc.), which may be integral to the transaction processing server 202. The monitoring system 204 may include one or more servers programmed and/or configured to execute remedial processes, such as compliance or fraud processes on transaction requests. The system 200 may include a scoring server 106 including a scoring engine 108 programmed and/or configured to generate similarity scores of two or more strings, such as according to the foregoing enhanced n-gram models. The scoring server 106 may be integral to the transaction processing server 202. The transaction processing server 202, monitoring system 204, and scoring server 106 may be in communication via a communication interface 104, e.g., an application programming interface, a message broker, and/or the like. One or more servers, e.g., the scoring server 106, may be in communication with a database 110 for storing compared strings, similarity scores, and/or the like.

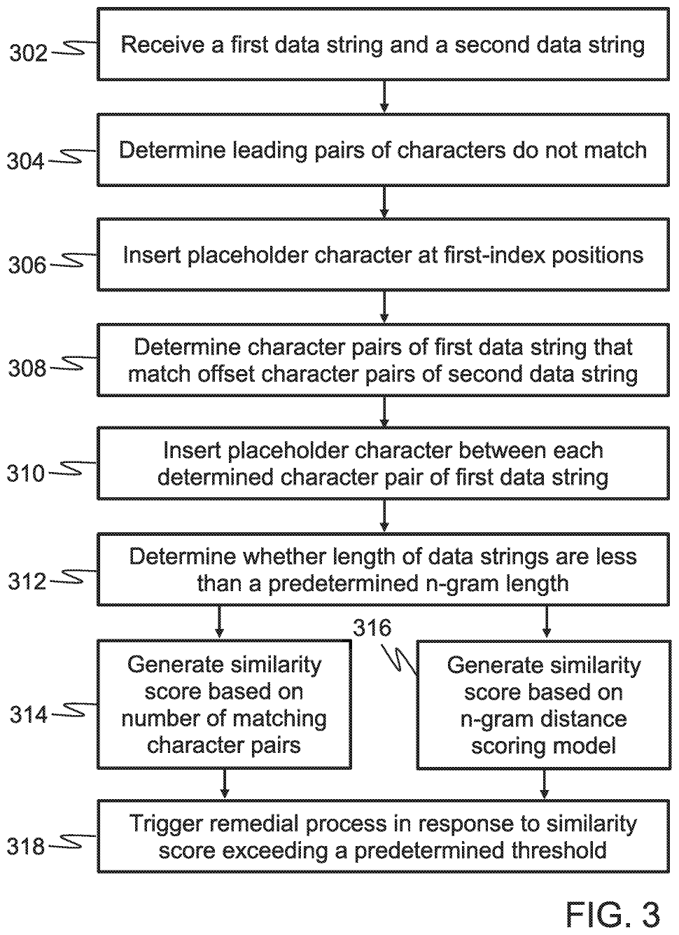

Referring now to FIG. 3, shown is a method of generating and using enhanced n-gram models, according to non-limiting embodiments. One or more steps of the method may be performed by a scoring server 106 or dependent server 102, such as a transaction processing server 202 and/or monitoring system 204 server. A step executed by one server may be executed by a same or different server as another depicted step. One or more servers may be combined in the foregoing. Furthermore, the steps may be repeated for additional string comparisons. In step 302, the transaction processing server may receive a first data string in a first transaction request and a second data string in a second transaction request, such as during processing of the transaction requests. In step 304, the transaction processing server or scoring server may determine that a leading pair of characters of the first data string does not match a leading pair of characters of the second data string. In response to determining that the leading pair of characters of the first data string does not match the leading pair of characters of the second data string, in step 306, the transaction processing server or scoring server may insert a placeholder character at a first-index position (e.g., front of string) in the first data string and at a first-index position in the second data string. Placeholder characters, as referred to herein, may describe characters not present elsewhere in the first data string or the second data string.

In step 308, the transaction processing server or scoring server may determine at least one character pair of the first data string in which a first character of the at least one character pair matches a character of the second data string at a same index position as the first character (e.g., Xₙ=Yₙ) and in which a second character of the at least one character pair matches a character of the second data string at an index position immediately following a same index position of the second character (e.g., Xₙ₊₁=Yₙ₊₂) (e.g., the character pair “mo” when comparing “kmoq” to “Imno”). One or more such character pairs in the first data string may be determined. In step 310, the transaction processing server or the scoring server may insert a placeholder character between each character pair so determined (e.g., “mo” in “kmoq” may become “km˜oq”).

In step 312, the transaction processing server or scoring server may determine whether a length of the first data string or a length of the second data string is less than a predetermined n-gram length (e.g., n-gram length of 3). The predetermined n-gram length may be any viable length for comparison according to the above-described methods. In response to determining that the length of the first data string or the length of the second data string is less than the predetermined n-gram length, in step 314, the transaction processing server or scoring server may generate a similarity score based on a number of matching character pairs at a same index in the first data string and the second data string in relation to the total number of character pairs. In response to determining that the length of the first data string and the length of the second data string are greater than or equal to the predetermined n-gram length, in step 316, the transaction processing server or scoring server may generate the similarity score based on an n-gram distance scoring model to compare the first-data string and the second data string. In step 318, the transaction processing server or monitoring system may trigger a remedial process for the first transaction request and/or the second transaction request in response to the similarity score exceeding a predetermined threshold (e.g., for normalized scores from 0 to 1, a threshold may be set at 0.5 or higher). A predetermined threshold may be set at any viable level determined to efficiently balance false positives and false negatives.

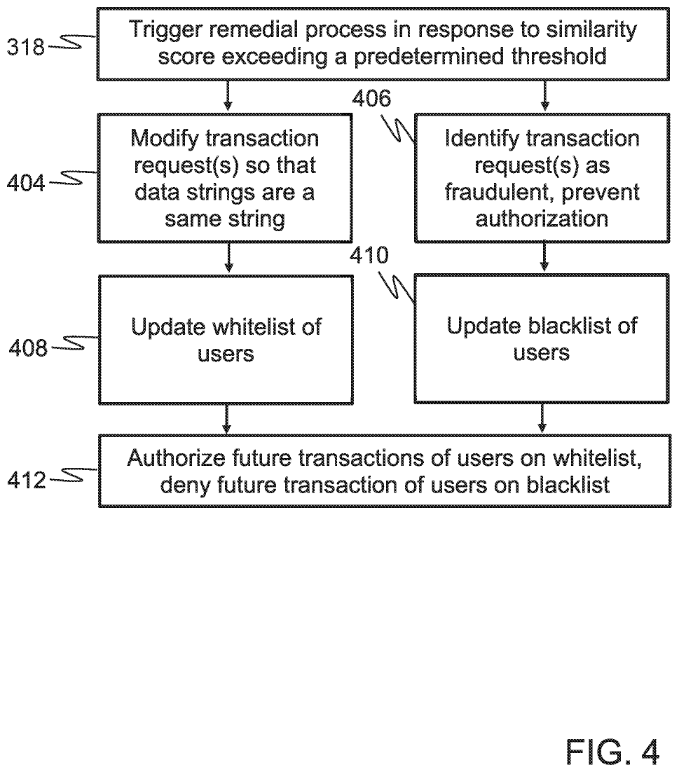

Referring now to FIG. 4, shown is a method of generating and using enhanced n-gram models, according to non-limiting embodiments. One or more steps of the method may be performed by a scoring server 106 or dependent server 102, such as a transaction processing server 202 and/or monitoring system 204 server. A step executed by one server may be executed by a same or different server as another depicted step. One or more servers may be combined in the foregoing. Furthermore, the steps may be repeated for additional string comparisons. In step 318, the monitoring system may trigger a remedial process for the first transaction request and/or the second transaction request in response to the similarity score exceeding a predetermined threshold. The monitoring system may be a compliance system, and the remedial process may include, in step 404, modifying data of the first transaction request and/or the second transaction request so that the first data string and the second data string are a same data string (e.g., same name, same identifier, same data field, etc.). A compliance system may then update a whitelist of users in step 408.

The monitoring system may also be a fraud system, and the remedial process may include, in step 406, identifying the first transaction request and/or the second transaction request as fraudulent and preventing authorization of the first transaction request and/or the second transaction request. Fraud systems running fraud detection models that are reliant on accurate sets of data from a same user, for example, may rely on accurate matching of transactions from same users. The fraud system may then, in step 410, update a blacklist of users. In step 412, the transaction processing system or monitoring system may authorize future transaction requests of users on the whitelist and/or deny authorization of future transaction requests of users on the blacklist.

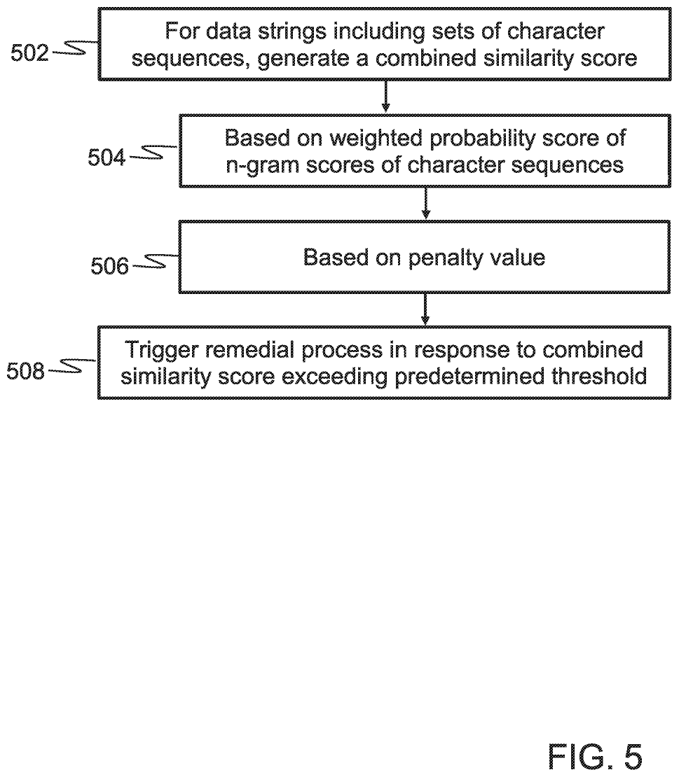

Referring now to FIG. 5, provided is a method of generating and using enhanced n-gram models, according to non-limiting embodiments. One or more steps of the method may be performed by a scoring server 106 or dependent server 102, such as a transaction processing server 202 and/or monitoring system 204 server. A step executed by one server may be executed by a same or different server as another depicted step. One or more servers may be combined in the foregoing. Furthermore, the steps may be repeated for additional string comparisons. For the depicted method, the first data string and the second data string may respectively include sets of character sequences (e.g., a person's name divided into first, middle, and/or last name sequences). In step 502, the transaction processing server or scoring server may generate a combined similarity score of the first set of character sequences compared to the second set of character sequences. The combined similarity score may be based, in step 504, on a weighted probability score including a summed plurality of probability scores divided by a number of character sequences in the first set of character sequences. Each of the plurality of probability scores may represent a probability that a character sequence in the first set of character sequences exists in the second set of character sequences. Each probability score of the plurality of probability scores may be based on an n-gram distance model, such as the enhanced n-gram models described above. The combined similarity score may also be based on, in step 506, a penalty value assessed for each character sequence in the second set of character sequences that does not exist in the first set of character sequences.

In step 508, the transaction processing server or monitoring server may trigger the remedial process for the first transaction request and/or the second transaction request in response to the combined similarity score exceeding a predetermined threshold (e.g., for normalized scores from 0 to 1, a threshold may be set at 0.75 or higher). A predetermined threshold may be set at any viable level determined to efficiently balance false positives and false negatives.

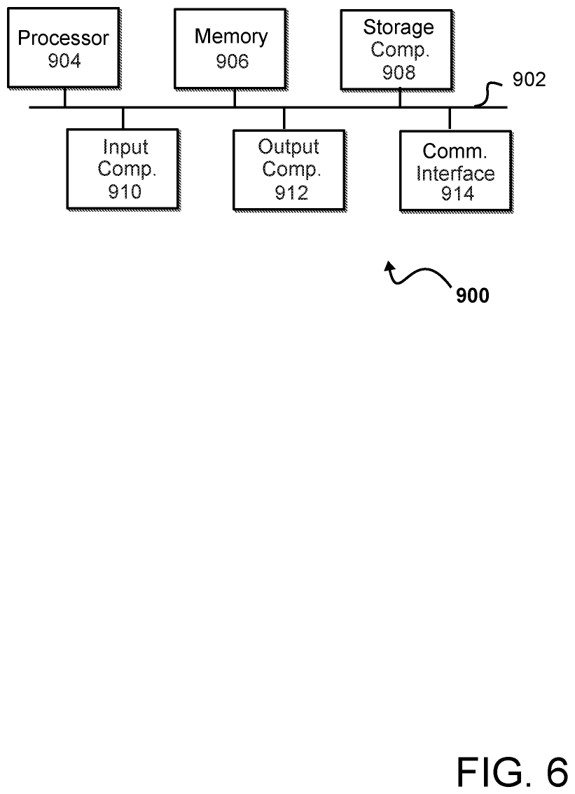

Referring now to FIG. 6, shown is a diagram of example components of a device 900 according to non-limiting embodiments or aspects. Device 900 may correspond to the dependent server 102, such as a transaction processing server 202 or monitoring system 204 server (e.g., compliance system server, fraud system server, etc.), communication interface 104, and/or scoring server 106 in FIGS. 1 and 2, as an example. In some non-limiting embodiments or aspects, such systems or devices may include at least one device 900 and/or at least one component of device 900. The number and arrangement of components shown are provided as an example. In some non-limiting embodiments or aspects, device 900 may include additional components, fewer components, different components, or differently arranged components than those shown in FIG. 1. Additionally, or alternatively, a set of components (e.g., one or more components) of device 900 may perform one or more functions described as being performed by another set of components of device 900.

As shown in FIG. 6, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 6, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is

1. A computer-implemented method comprising:
receiving, with at least one processor, a first data string in a first transaction request and a second data string in a second transaction request processed by a transaction processing server;
determining, with at least one processor, that a leading pair of characters of the first data string does not match a leading pair of characters of the second data string;
in response to determining that the leading pair of characters of the first data string does not match the leading pair of characters of the second data string, inserting, with at least one processor, a placeholder character at a first-index position in the first data string and at a first-index position in the second data string, wherein placeholder characters are not present elsewhere in the first data string or the second data string;
determining, with at least one processor, at least one character pair of the first data string in which a first character of the at least one character pair matches a character of the second data string at a same index position as the first character and in which a second character of the at least one character pair matches a character of the second data string at an index position immediately following a same index position of the second character;
inserting, with at least one processor, a placeholder character between each character pair of the at least one character pair;
determining, with at least one processor, whether a length of the first data string or a length of the second data string is less than a predetermined n-gram length, and
(i) in response to determining that the length of the first data string or the length of the second data string is less than the predetermined n-gram length, generating, with at least one processor, a similarity score based on a number of matching character pairs at same indexes in the first data string and the second data string in relation to the total number of character pairs, or
(ii) in response to determining that the length of the first data string and the length of the second data string are greater than or equal to the predetermined n-gram length, generating, with at least one processor, the similarity score based on an n-gram distance scoring model to compare the first data string and the second data string; and
triggering, by a monitoring system in communication with the transaction processing server, a remedial process for the first transaction request and/or the second transaction request in response to the similarity score exceeding a predetermined threshold.

2. The computer-implemented method of claim 1, wherein the monitoring system is a compliance system, and wherein the remedial process executed by the compliance system comprises modifying, with a compliance system server, the first transaction request and/or the second transaction request so that the first data string and the second data string are a same data string.

3. The computer-implemented method of claim 2, further comprising updating, by the compliance system after executing the remedial process, a whitelist of users, wherein the transaction processing server is configured to authorize future transaction requests of users on the whitelist.

4. The computer-implemented method of claim 1, wherein the monitoring system is a fraud system, and wherein the remedial process executed by the fraud system comprises identifying the first transaction request and/or the second transaction request as fraudulent and preventing authorization of the first transaction request and/or the second transaction request.

5. The computer-implemented method of claim 4, further comprising updating, by the fraud system after executing the remedial process, a blacklist of users, wherein the transaction processing server is configured to deny authorization of future transaction requests of users on the blacklist.

6. The computer-implemented method of claim 1, wherein the first data string comprises a first set of character sequences and the second data string comprises a second set of character sequences, the method further comprising:
generating, with at least one processor, a combined similarity score of the first set of character sequences compared to the second set of character sequences, the combined similarity score based on:
a weighted probability score comprising a summed plurality of probability scores divided by a number of character sequences in the first set of character sequences, wherein each of the plurality of probability scores represents a probability that a character sequence in the first set of character sequences exists in the second set of character sequences; and
a penalty value assessed for each character sequence in the second set of character sequences that does not exist in the first set of character sequences;
wherein each probability score of the plurality of probability scores is based on an n-gram distance model.

7. The computer-implemented method of claim 6, further comprising triggering, by the monitoring system, the remedial process for the first transaction request and/or the second transaction request in response to the combined similarity score exceeding a predetermined threshold.

8. A system comprising a transaction processing server including at least one processor and a monitoring system in communication with the transaction processing server, wherein the transaction processing server is programmed and/or configured to:
receive a first data string in a first transaction request and a second data string in a second transaction request processed by a transaction processing server;
determine that a leading pair of characters of the first data string does not match a leading pair of characters of the second data string;
in response to determining that the leading pair of characters of the first data string does not match the leading pair of characters of the second data string, insert a placeholder character at a first-index position in the first data string and at a first-index position in the second data string, wherein placeholder characters are not present elsewhere in the first data string or the second data string;
determine at least one character pair of the first data string in which a first character of the at least one character pair matches a character of the second data string at a same index position as the first character and in which a second character of the at least one character pair matches a character of the second data string at an index position immediately following a same index position of the second character;
insert a placeholder character between each character pair of the at least one character pair;
determine whether a length of the first data string or a length of the second data string is less than a predetermined n-gram length, and
(i) in response to determining that the length of the first data string or the length of the second data string is less than the predetermined n-gram length, generate a similarity score based on a number of matching character pairs at same indexes in the first data string and the second data string in relation to the total number of character pairs, or
(ii) in response to determining that the length of the first data string and the length of the second data string are greater than or equal to the predetermined n-gram length, generate the similarity score based on an n-gram distance scoring model to compare the first data string and the second data string; and
wherein the monitoring system is programmed and/or configured to trigger a remedial process for the first transaction request and/or the second transaction request in response to the similarity score exceeding a predetermined threshold.

9. The system of claim 8, wherein the monitoring system is a compliance system, and wherein the remedial process executed by the compliance system comprises modifying, with a compliance system server, the first transaction request and/or the second transaction request so that the first data string and the second data string are a same data string.

10. The system of claim 9, wherein the compliance system is programmed and/or configured to update, after executing the remedial process, a whitelist of users, and wherein the transaction processing server is further programmed and/or configured to authorize future transaction requests of users on the whitelist.

11. The system of claim 8, wherein the monitoring system is a fraud system, and wherein the remedial process executed by the fraud system comprises identifying the first transaction request and/or the second transaction request as fraudulent and preventing authorization of the first transaction request and/or the second transaction request.

12. The system of claim 11, wherein the fraud system is programmed and/or configured to update, after executing the remedial process, a blacklist of users, and wherein the transaction processing server is further programmed and/or configured to deny authorization of future transaction requests of users on the blacklist.

13. The system of claim 8, wherein the first data string comprises a first set of character sequences and the second data string comprises a second set of character sequences, and wherein the transaction processing server is further programmed and/or configured to:
generate a combined similarity score of the first set of character sequences compared to the second set of character sequences, the combined similarity score based on:
a weighted probability score comprising a summed plurality of probability scores divided by a number of character sequences in the first set of character sequences, wherein each of the plurality of probability scores represents a probability that a character sequence in the first set of character sequences exists in the second set of character sequences; and
a penalty value assessed for each character sequence in the second set of character sequences that does not exist in the first set of character sequences;
wherein each probability score of the plurality of probability scores is based on an n-gram distance model.

14. The system of claim 13, wherein the monitoring system is further programmed and/or configured to trigger the remedial process for the first transaction request and/or the second transaction request in response to the combined similarity score exceeding a predetermined threshold.

15. A computer program product comprising at least one non-transitory computer-readable medium including program instructions that, when executed by at least one processor, cause the at least one processor to:
receive a first data string in a first transaction request and a second data string in a second transaction request processed by a transaction processing server;
determine that a leading pair of characters of the first data string does not match a leading pair of characters of the second data string;
in response to determining that the leading pair of characters of the first data string does not match the leading pair of characters of the second data string, insert a placeholder character at a first-index position in the first data string and at a first-index position in the second data string, wherein placeholder characters are not present elsewhere in the first data string or the second data string;
determine at least one character pair of the first data string in which a first character of the at least one character pair matches a character of the second data string at a same index position as the first character and in which a second character of the at least one character pair matches a character of the second data string at an index position immediately following a same index position of the second character;
insert a placeholder character between each character pair of the at least one character pair;
determine whether a length of the first data string or a length of the second data string is less than a predetermined n-gram length, and
(i) in response to determining that the length of the first data string or the length of the second data string is less than the predetermined n-gram length, generate a similarity score based on a number of matching character pairs at same indexes in the first data string and the second data string in relation to the total number of character pairs, or
(ii) in response to determining that the length of the first data string and the length of the second data string are greater than or equal to the predetermined n-gram length, generate the similarity score based on an n-gram distance scoring model to compare the first data string and the second data string; and
trigger a remedial process of a monitoring system in communication with the transaction processing server for the first transaction request and/or the second transaction request in response to the similarity score exceeding a predetermined threshold.

16. The computer program product of claim 15, wherein the monitoring system is a compliance system, and wherein the remedial process executed by the compliance system comprises modifying, with a compliance system server, the first transaction request and/or the second transaction request so that the first data string and the second data string are a same data string.

17. The computer program product of claim 16, wherein the program instructions further cause the at least one processor to trigger the compliance system to update, after executing the remedial process, a whitelist of users, wherein the transaction processing server is configured to authorize future transaction requests of users on the whitelist.

18. The computer program product of claim 15, wherein the monitoring system is a fraud system, and wherein the remedial process executed by the fraud system comprises identifying the first transaction request and/or the second transaction request as fraudulent and preventing authorization of the first transaction request and/or the second transaction request.

19. The computer program product of claim 18, wherein the program instructions further cause the at least one processor to trigger the fraud system to update, after executing the remedial process, a blacklist of users, wherein the transaction processing server is configured to deny authorization of future transaction requests of users on the blacklist.

20. The computer program product of claim 15, wherein the first data string comprises a first set of character sequences and the second data string comprises a second set of character sequences, and wherein the program instructions further cause the at least one processor to:
generate a combined similarity score of the first set of character sequences compared to the second set of character sequences, the combined similarity score based on:
a weighted probability score comprising a summed plurality of probability scores divided by a number of character sequences in the first set of character sequences, wherein each of the plurality of probability scores represents a probability that a character sequence in the first set of character sequences exists in the second set of character sequences; and
a penalty value assessed for each character sequence in the second set of character sequences that does not exist in the first set of character sequences; and
trigger the monitoring system to execute the remedial process for the first transaction request and/or the second transaction request in response to the combined similarity score exceeding a predetermined threshold,
wherein each probability score of the plurality of probability scores is based on an n-gram distance model.
